(19) United States
(12) Patent Application Publication
(10) Pub. No.: US 2014/0198322 A1
(43) Pub. Date: Jul. 17, 2014

(54) Surface Profile Measurement System

(71) Applicant: SAMSUNG ELECTRONICS CO., LTD., SUWON-SI (KR)

(72) Inventors: Kwang Soo Kim, Suwon-Si (KR); Hyun-Jae Lee, Suwon-Si (KR); Myoung-Ki Ahn, Yongin-Si (KR); Byeong-Hwan Jeon, Yongin-Si (KR)

(73) Assignee: SAMSUNG ELECTRONICS CO., LTD., SUWON-SI (KR)

(21) Appl. No.: 14/040,098

(22) Filed: Sep. 27, 2013

(30) Foreign Application Priority Data
Jan. 17, 2013 (KR) 10-2012-0005494

(51) Int. Cl. G01B 11/24

(52) U.S. Cl. CPC G01B 11/24
USPC 356/625

(57) ABSTRACT

A profile measurement system includes a light source configured to generate light. A beam shaper configured to shape the light generated from the light source. A beam splitter configured to partially transmit and reflect the light shaped by the beam shaper. An object lens configured to receive the light from the beam splitter and irradiate the light to a stage in which a workpiece is mounted. A profile estimating part has a plurality of continuously varying focal points. The profile estimating part includes a focusing lens and a light detector configured to receive the light transmitted through the focusing lens.

### CROSS-REFERENCE TO RELATED APPLICATION

This application claims priority under 35 U.S.C. §119 to Korean Patent Application No. 10-2012-0005494 filed on Jan. 17, 2013, the disclosure of which is incorporated by reference herein in its entirety.

### TECHNICAL FIELD

The present inventive concept relates to a measurement system, and more particularly, to a surface profile measurement system.

### DISCUSSION OF RELATED ART

Systems for measuring a surface profile may calculate an optimal focal point by measuring changes in imaging areas several times, and estimating surface profiles by location. Systems for measuring a surface profile may have low resolution and low throughput. It may be difficult to apply systems for measuring a surface profile to a mass-production process.

### SUMMARY

Exemplary embodiments of the present inventive concept provide a system for optically measuring a surface profile of a workpiece.

Exemplary embodiments of the present inventive concept provide a method of optically measuring a surface profile of a workpiece.

Exemplary embodiments of the present inventive concept provide a system including a profile estimating part. The profiling estimating part may have a continuously varying focal line.

Exemplary embodiments of the present inventive concept are not limited to the above disclosure; other exemplary embodiments of the present inventive concept may become apparent based on the following descriptions.

A profile measurement system may include a light source configured to generate light. A beam shaper may be configured to shape the light generated from the light source. A beam splitter may be configured to partially transmit and reflect the light shaped by the beam shaper. An object lens may be configured to receive the light from the beam splitter and irradiate the light to a stage in which a workpiece is mounted. A profile estimating part may have a plurality of continuously varying focal points. The profile estimating part may include a focusing lens and a light detector configured to receive the light transmitted through the focusing lens.

A profile measurement system may include a light source configured to generate light. A beam shaper may be configured to shape the light generated from the light source in a bar shape. An object lens may be configured to transmit the bar-shaped light to be irradiated on an irradiation area disposed on a surface of a workpiece. A beam splitter may be configured to receive the light reflected from the irradiation area disposed on the surface of the workpiece to be transferred to a profile estimating part. The profile estimating part may include a cylindrical focusing lens having a focal line extending in a direction perpendicular to an alignment direction of the light reflected from the irradiation area. A light detector may have a sensing plane on which the light transmitted through the focusing lens splits in the same direction as the focal line.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1A is a schematic view showing a profile measurement system in accordance with exemplary embodiments of the present inventive concept;

FIG. 1B is a schematic view showing a focusing lens of the profile measurement system in accordance with exemplary embodiments of the present inventive concept;

FIGS. 2A to 2C are views illustrating a surface level of a workpiece measured using the profile measurement system in accordance with exemplary embodiments of the present inventive concept;

FIG. 3A is a schematic view showing a profile measurement system in accordance with exemplary embodiments of the present inventive concept;

FIG. 3B is a schematic view showing a focusing lens of the profile measurement system in accordance with exemplary embodiments of the present inventive concept;

FIGS. 4A to 4C are views illustrating a surface level of a workpiece being measured using the profile measurement system in accordance with exemplary embodiments of the present inventive concept;

FIG. 5 is a schematic view showing a profile measurement system in accordance with exemplary embodiments of the present inventive concept;

FIGS. 6A to 6C are views illustrating a surface level of a workpiece being measured using the profile measurement system;

FIG. 7 is a schematic view showing a profile measurement system in accordance with exemplary embodiments of the present inventive concept;

FIGS. 8A to 8C are views illustrating a surface level of a workpiece being measured using the profile measurement system;

FIG. 9 is a schematic view showing a profile measurement system in accordance with exemplary embodiments of the present inventive concept;

FIG. 10 is a schematic view showing a profile measurement system in accordance with exemplary embodiments of the present inventive concept;

FIGS. 11A and 11B are views illustrating a surface profile of a workpiece being measured using the profile measurement system;

FIGS. 12A and 12B are schematic views showing profile measurement systems in accordance with exemplary embodiments of the present inventive concept;

FIGS. 13A and 13B are views illustrating a surface level of a workpiece being measured using the profile measurement systems; and

FIG. 14 is a schematic view showing a profile measurement system in accordance with exemplary embodiments of the present inventive concept.

### DETAILED DESCRIPTION

Various exemplary embodiments of the present inventive concept will now be described more fully with reference to the accompanying drawings in which exemplary embodiments of the present inventive concept are shown. Exemplary embodiments of the present inventive concept may, however, be embodied in different forms and should not be construed as limited to the embodiments set forth herein. Rather, these embodiments are provided so that this disclosure is thorough and complete and fully conveys the present inventive concept to those skilled in the art. In the drawings, the sizes and relative sizes of layers and regions may be exaggerated for convenience of explanation.

It will be understood that when an element is referred to as being “connected” or “coupled” to another element, it can be directly connected or coupled to the other element or intervening elements may be present.

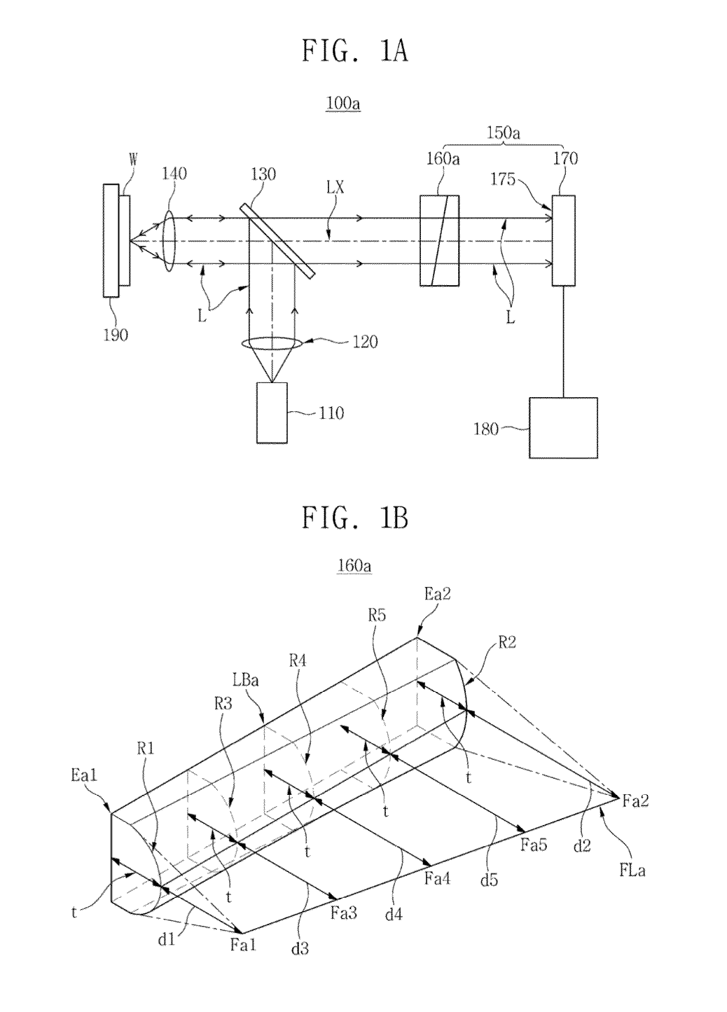

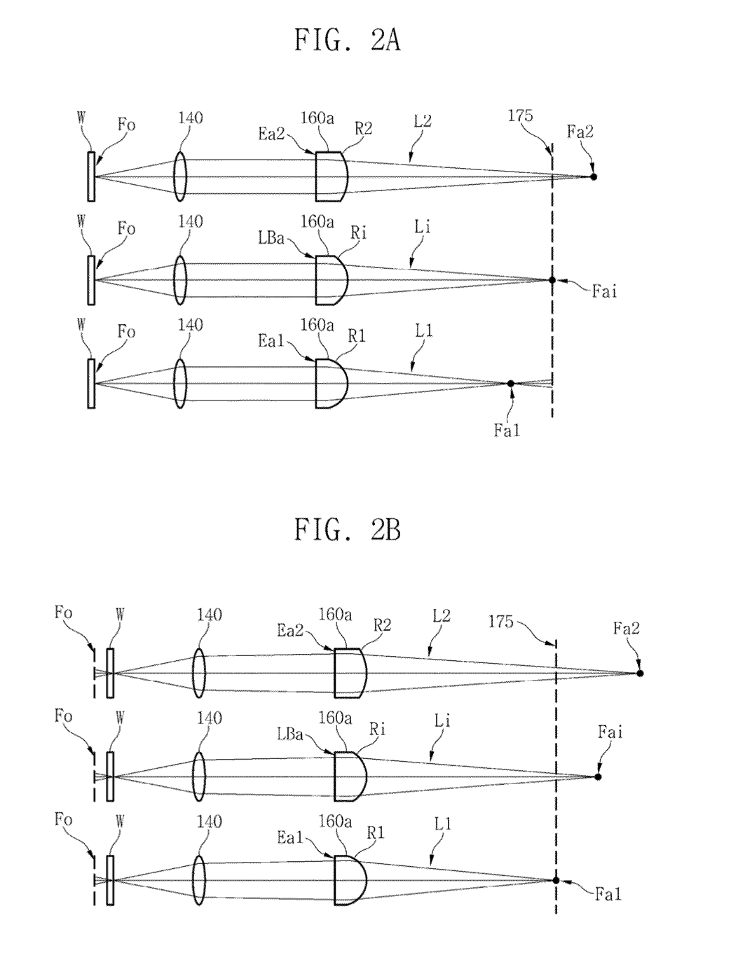

FIG. 1A is a schematic view showing a profile measurement system 100a in accordance with exemplary embodiments of the present inventive concept.

Referring to FIG. 1A, the profile measurement system 100a may include a light source 110, a field lens 120, a beam splitter 130, an object lens 140, profile estimating part 150a, and a stage 190. The profile measurement system 100a may include a control part 180 which may communicate with the profile estimating part 150a. The profile estimating part 150a may include a focusing lens 160a and a light detector 170.

The light source 110 may generate light L radially. The light source 110 may provide UV light and/or laser light. The light L may have a single wavelength. The light source 110 may generate the light L in various shapes such as a spot, a line, a bar, a circle, a disk, or a polygon. The light L generated from the light source 110 may be irradiated to the field lens 120. The field lens 120 may adjust the light L received from the light source 110 to be a straight parallel beam, and the light L may be irradiated to the beam splitter 130. The beam splitter 130 may partially reflect and partially transmit the light L received from the light source 110 and/or the field lens 120. For example, the beam splitter 130 may include a semi-transparent mirror or a semi-reflective lens. The object lens 140 may irradiate the light L received from the beam splitter 130 to a workpiece W. The workpiece W may include a semiconductor wafer, a flat display panel such as an LCD, or other various targets of which surface profiles are to be measured. The light L irradiated to the workpiece W may be reflected toward the object lens 140. The light L reflected from the workpiece W may be transmitted through the object lens 140. The light L may be irradiated back to the beam splitter 130 through the object lens 140. Light L irradiated back to beam splitter 130 may be transmitted through the beam splitter 130, and the light L may be irradiated to the focusing lens 160a of the profile estimating part 150a.

The profile estimating part 150a may have a plurality of continuously varying focal points. For example, the profile estimating part 150a may include a focusing lens 160a with a continuous variation of the curvature, and a light detector 170.

The focusing lens 160a may adjust the light L received from the beam splitter 130 to have various focal positions. The focusing lens 160a may irradiate the light L to the light detector 170. The focusing lens 160a may be arranged in such a way that a surface receiving the light L is perpendicular to a light axis LX.

The light detector 170 may collect the light L transmitted and/or irradiated from the focusing lens 160a. For example, the light detector 170 may display the light L received from the focusing lens 160a in various shapes, such as an optical image or a light intensity profile, or convert the light L received from the focusing lens 160a to an optical image or electronic file data. For example, the light detector 170 may include a charge coupled device (CCD) or a CMOS image sensor (CIS). A sensing plane 175 of the light detector 170 may be arranged to be perpendicular to the light axis LX.

The control part 180 may receive electric file data, such as the optical image or intensity profile from the light detector 170, and may analyze and/or estimate a surface profile of the workpiece W. The control part 180 may include a microprocessor and a data storage part.

The stage 190 may mount the workpiece W. The stage 190 may move up and down, and left and right. For example, the stage 190 may move freely in three dimensions. The stage 190 may move according to the focus position or focal plane of the object lens 140.

The profile measurement system 100a in accordance with exemplary embodiments of the present inventive concept may measure a surface level of the workpiece W through a single optical image pickup. The profile measurement system 100a may have line-shaped focuses varying linearly or continuously. The surface level of the workpiece W may be accurately measured through a single optical photographing.

FIG. 1B is a schematic view showing a focusing lens 160a of the profile measurement system 100a in accordance with exemplary embodiments of the present inventive concept.

Referring to FIG. 1B, the focusing lens 160a of exemplary embodiments of the present inventive concept may include a semi-cylindrical lens. The thickness of the lens may vary either linearly or according to a smooth curve. The focusing lens 160a may include a first end Ea1, a second end Ea2, and a lens body LBa located between the first end Ea1 and the second end Ea2. The first end Ea1 may have a first radius of curvature R1, the second end Ea2 may have a second radius of curvature R2 greater than the first radius of curvature R1, and the lens body LBa may have body radii of curvatures R3, R4, and R5 between the first radius of curvature R1 and the second radius of curvature R2 (e.g. R1<R3<R4<R5<R2). The first radius of curvature R1, the body radii of curvatures R3, R4, and R5, and the second radius of curvature R2 may vary analogically or continuously. The focusing lens 160a may have a consistent maximum thickness t. The focusing lens 160a may have a plurality of focal points Fa1, Fa2, Fa3, Fa4, and Fa5. Each of the focal points may depend on the radii of curvatures R1, R2, R3, R4, and R5. For example, the first end Ea1 of the focusing lens 160a may have a first focal point Fa1 with a first focusing distance d1, the second end Ea2 may have a second focal point Fa2 with a second focusing distance d2 greater than the first focusing distance d1, and the lens body LBa may have intermediate focal points Fa3, Fa4, and Fa5 with intermediate focusing distances d3, d4, and d5 between the first focusing distance d1 and the second focusing distance d2 (e.g. d1<d3<d4<d5<d2). The focal points Fa1, Fa2, Fa3, Fa4, and Fa5 of the focusing lens 160a may form a focusing line FLa in a continuous straight line shape connecting all of the focal points Fa1, Fa2, Fa3, Fa4, and Fa5 according to changes of the radii of curvatures R1, R2, R3, R4, and R5 and/or focusing distances d1, d2, d3, d4, and d5. The focusing line FLa may be tilted with respect to the light axis LX and the sensing plane 175 of the light detector 170.

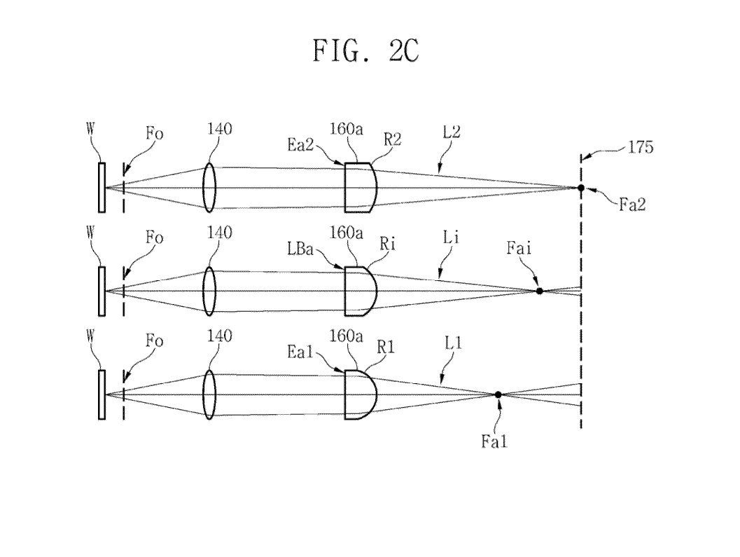

FIGS. 2A to 2C are views for describing a surface level of a workpiece W being measured using the profile measurement system 100a in accordance with exemplary embodiments of the present inventive concept.

Referring to FIGS. 2A to 2C, each of the lights L1, L2, and Li reflected from the workpiece W may be transmitted through the focusing lens 160a and may be irradiated to the sensing plane 175 of the light detector 170. Each of the focal points Fa1, Fa2, and Fai of the focusing lens 160a may be variously located. The light L1 which may be transmitted through the first end Ea1 of the focusing lens 160a having the relatively small first radius of curvature R1, may have the first focal point Fa1 relatively close to the focusing lens 160a. The light L2 which may be transmitted through the second end Ea2 of the focusing lens 160a having the relatively large second radius of curvature R2, may have the second focal point Fa2 relatively far from the focusing lens 160a. The light Li which may be transmitted through the lens body LBa of the focusing lens 160a with an intermediate radius of curvature Ri between the first radius of curvature L1 and the second radius of curvature L2, may have an intermediate focal point Fai located between the first focal point Fa1 and the second focal point Fa2.

For example, with reference to FIG. 2A, if a surface of the workpiece W is arranged to match a focal surface Fo of the object lens 140 and the light Li which may be transmitted through the lens body LBa of the focusing lens 160a is focused on the sensing plane 175 of the light detector 170, the light L1 which may be transmitted through a part close to the first end Ea1 of the focusing lens 160a may be focused in front of the sensing plane 175, and the light L2 which may be transmitted through the second end Ea2 of the focusing lens 160a may be focused in back of the sensing plane 175. Maximum intensity of the light Li may be obtained at the sensing plane 175 which matches the intermediate focal point Fai.

For example, referring to FIG. 2B, if the surface of the workpiece W is arranged to be closer than the focal surface Fo of the object lens 140, the light L1 which may be transmitted through a part close to the first end Ea1 of the focusing lens 160a may be focused on the sensing plane 175. Maximum intensity of the light L1 may be obtained at the sensing plane 175 close to the first focal point Fa1.

For example, referring to FIG. 2C, if the surface of the workpiece W is arranged to be farther than the focal surface Fo of the object lens 140, the light L2 which may be transmitted through a part close to the second end Ea2 of the focusing lens 160a may be focused on the sensing plane 175. Maximum intensity of the light L2 may be obtained at the sensing plane 175 close to the second focal point Fa2.

Referring to FIG. 2A to 2C, a mutual positional relationship between the surface of the workpiece W and the focal surface Fo of the object lens 140 may be estimated by analyzing intensity profiles of the lights L1, L2, and Li which reach the sensing plane 175 of the light detector 170.

The lights L1, L2, and Li reflected from the surface of the workpiece W may have a continuous intensity distribution on the sensing plane 175. For example, on the sensing plane 175, the intensity of the lights L1, L2, and Li may have a Gaussian distribution. The surface level of the workpiece W may be measured and estimated through a single optical photographing.

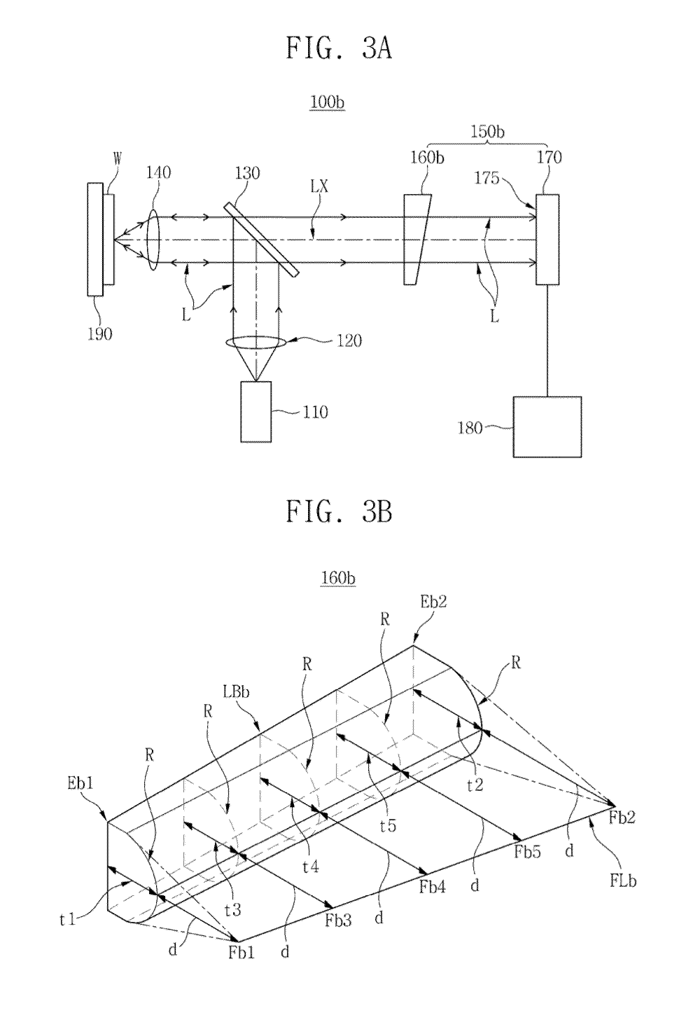

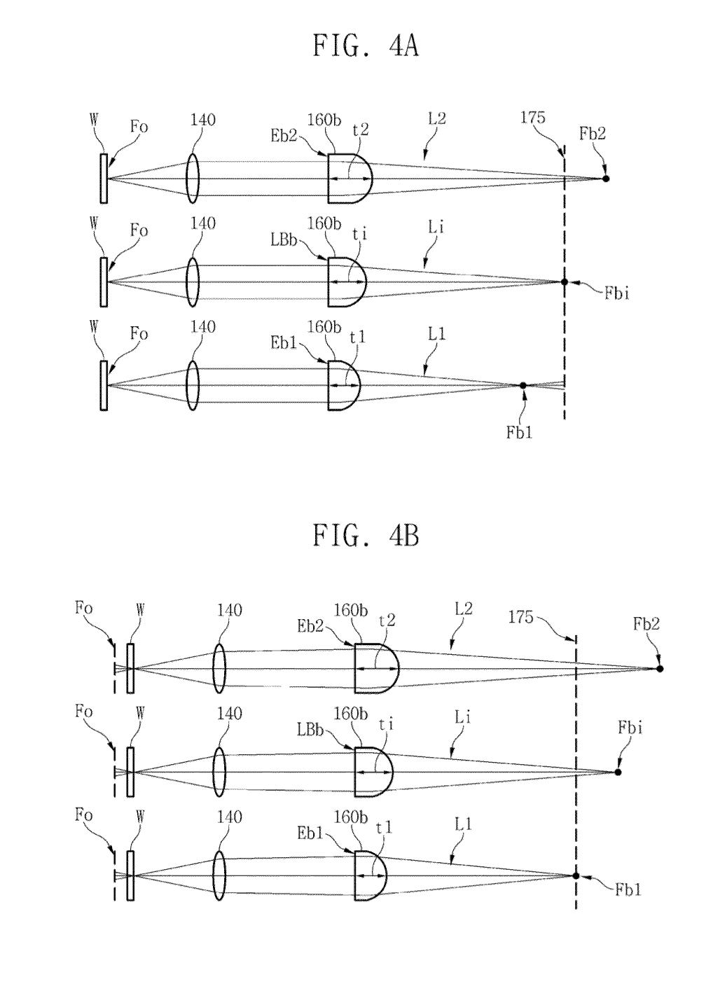

FIG. 3A is a schematic view showing a profile measurement system 100b in accordance with exemplary embodiments of the present inventive concept.

Referring to FIG. 3A, the profile measurement system 100b may include a light source 110, a field lens 120, a beam splitter 130, an object lens 140, a profile estimating part 150b, and a stage 190. The profile measurement system 100b may include a control part 180 which may communicate with the profile estimating part 150b. The profile estimating part 150b may have a plurality of continuously varying focal points. For example, the profile estimating part 150b may include a focusing lens 160b with a continuously varying thickness, and a light detector 170.

FIG. 3B is a schematic view showing a focusing lens 160b of the profile measurement system 100b in accordance with exemplary embodiments of the present inventive concept.

Referring to FIG. 3B, the focusing lens 160b may include a semi-cylindrical lens. The thickness of the lens may vary either linearly or according to a smooth curve.

For example, the focusing lens 160b may include a first end Eb1 with a first thickness t1, a second end Eb2 with a second thickness t2 greater than the first thickness t1, and a lens body LBb having intermediate thicknesses t3, t4, and t5 continuously varying between the first thickness t1 and the second thickness t2 (e.g. t1<t3<t4<t5<t2). The focusing lens 160b may have the same radius of curvature R overall.

The focusing lens 160b may have a plurality of focal points Fb1, Fb2, Fb3, Fb4, and Fb5. The focal points may depend on the thicknesses t1, t2, t3, t4, and t5. Distances d from the focusing lens 160b to the focal points Fb1, Fb2, Fb3, Fb4, and Fb5 may be the same.

The plurality of focal points Fb1, Fb2, Fb3, Fb4, and Fb5 of the focusing lens 160b may form a focusing line FLb in a continuous straight line. The focusing line FLb may connect all of the focal points Fb1, Fb2, Fb3, Fb4, and Fb5. The focal points may depend on the thicknesses t1, t2, t3, t4, and t5.

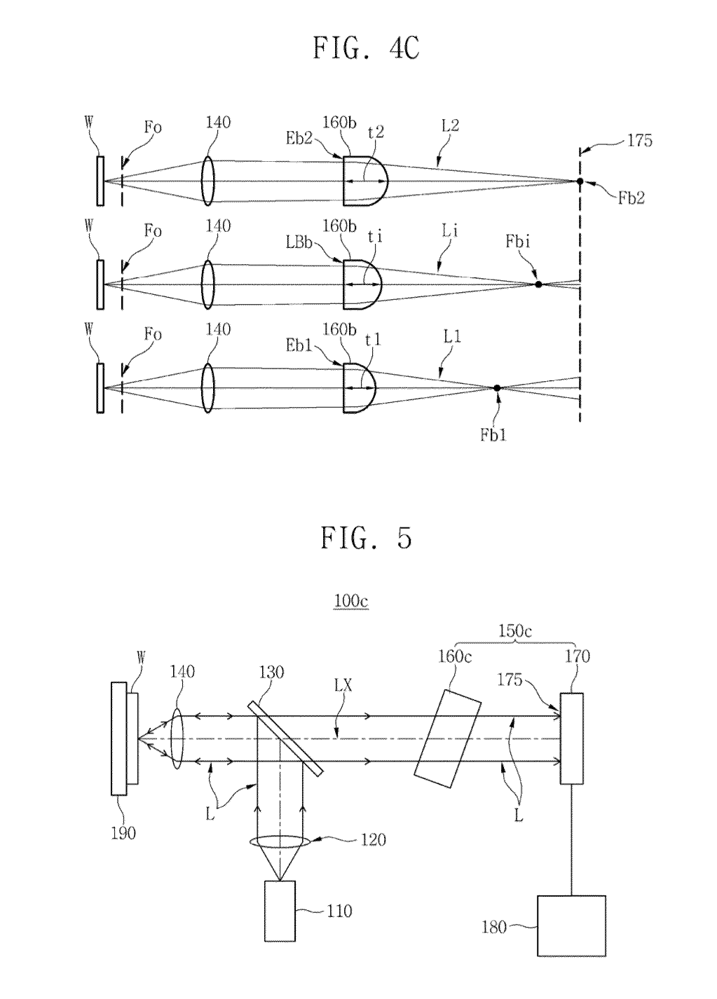

FIGS. 4A to 4C are views for describing a surface level of a workpiece W being measured using the profile measurement system 100b in accordance with exemplary embodiments of the present inventive concept.

Referring to FIG. 4A to 4C, the lights L1, L2, and Li reflected from the workpiece W may be transmitted through the focusing lens 160b and may be irradiated to the sensing plane 175 of the light detector 170. The focal points Fb1, Fb2, and Fbi of the focusing lens 160b may be variously located. The light L1 which may be transmitted through the first end Eb1 of the focusing lens 160b having the relatively small first thickness t1, may have the first focal point Fb1 relatively close to the focusing lens 160b. The light L2 which may be transmitted through the second end Eb2 of the focusing lens 160b having the relatively large second thickness t2, may have the second focal point Fb2 relatively far from the focusing lens 160b. The light Li which may be transmitted through the lens body LBb of the focusing lens 160b having an intermediate thickness ti between the first thickness t1 and the second thickness t2, may have an intermediate focal point Fbi located between the first focal point Fb1 and the second focal point Fb2.

For example, referring to FIG. 4A, if a surface of the workpiece W is arranged to match a focal surface Fo of the object lens 140 and the light Li which may be transmitted through the lens body LBb of the focusing lens 160b is focused on the sensing plane 175 of the light detector 170, the light L1 which may be transmitted through a part close to the first end Eb1 of the focusing lens 160b may be focused in front of the sensing plane 175 The light L2 which may be transmitted through the second end Eb2 of the focusing lens 160b may be focused in back of the sensing plane 175. Maximum intensity of the light Li may be obtained at the sensing plane 175 which matches the intermediate focal point Fbi.

For example, referring to FIG. 4B, if the surface of the workpiece W is arranged to be closer than the focal surface Fo of the object lens 140, the light L1 which may be transmitted through a part close to the first end Eb1 of the focusing lens 160b may be focused on the sensing plane 175. Maximum intensity of the light L1 may be obtained at the sensing plane 175 close to the first focal point Fb1.

For example, referring to FIG. 4C, if the surface of the workpiece W is arranged to be farther than the focal surface Fo of the object lens 140, the light L2 which may be transmitted through a part close to the second end Eb2 of the focusing lens 160b may be focused on the sensing plane 175. Maximum intensity of the light L2 may be obtained at the sensing plane 175 close to the second focal point Fb2.

Referring again to FIGS. 4A to 4C, a mutual positional relationship between the surface of the workpiece W and the focal surface Fo of the object lens 140 may be estimated by analyzing intensity profiles of the lights L1, L2, and Li which reach the sensing plane 175 of the light detector 170.

The lights L1, L2, and Li reflected from the surface of the workpiece W may show continuous intensity distribution on the sensing plane 175. For example, on the sensing plane 175, the intensity of the lights L1, L2, and Li may have a Gaussian distribution that is symmetrical with respect to the precise focal point. The surface level of the workpiece W may be measured and estimated through a single optical photographing.

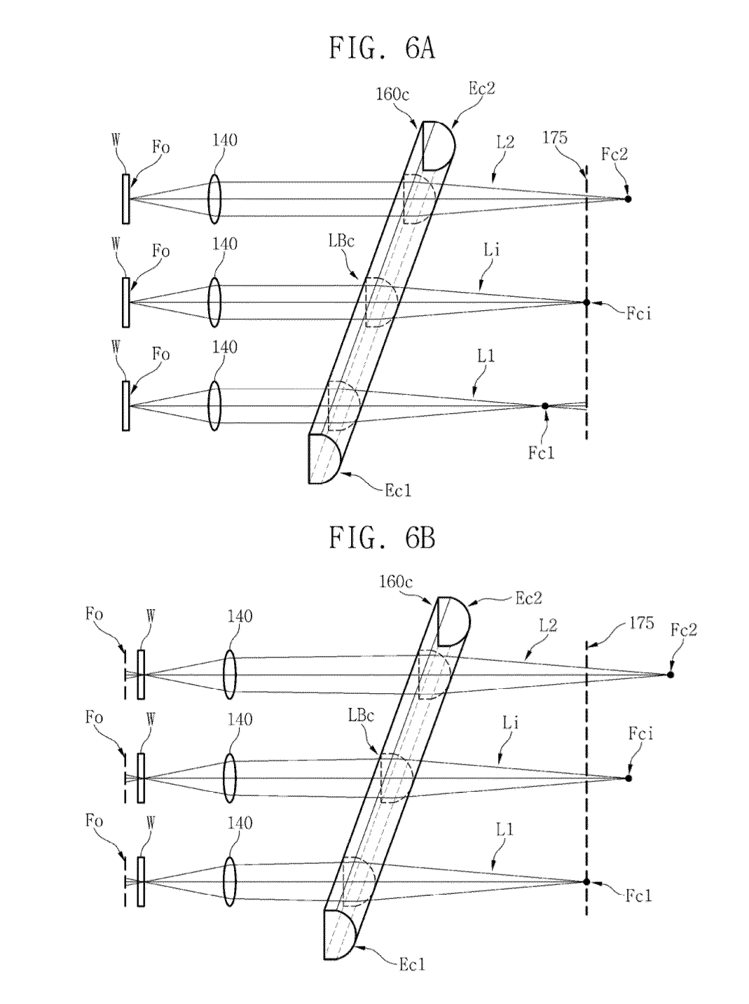

FIG. 5 is a schematic view showing a profile measurement system 100c in accordance with exemplary embodiments of the present inventive concept.

Referring to FIG. 5, the profile measurement system 100c of the exemplary embodiment may include a light source 110, a field lens 120, a beam splitter 130, an object lens 140, a profile estimating part 150c, and a stage 190. The profile estimating part 150c may include a focusing lens 160c arranged to be tilted with respect to a light axis LX. The focusing lens 160c may include a semi-cylindrical lens having a uniform curvature and thickness. The sensing plane 175 of the light detector 170 may be perpendicular to the light axis LX. The profile estimating part 150c may have a plurality of continuously varying focal points. For example, the focal points of the focusing lens 160c may be focused on the sensing plane 175. The focal points of the focusing lens 160c may continuously vary. The focusing lens 160c may be tilted with respect to the light axis LX.

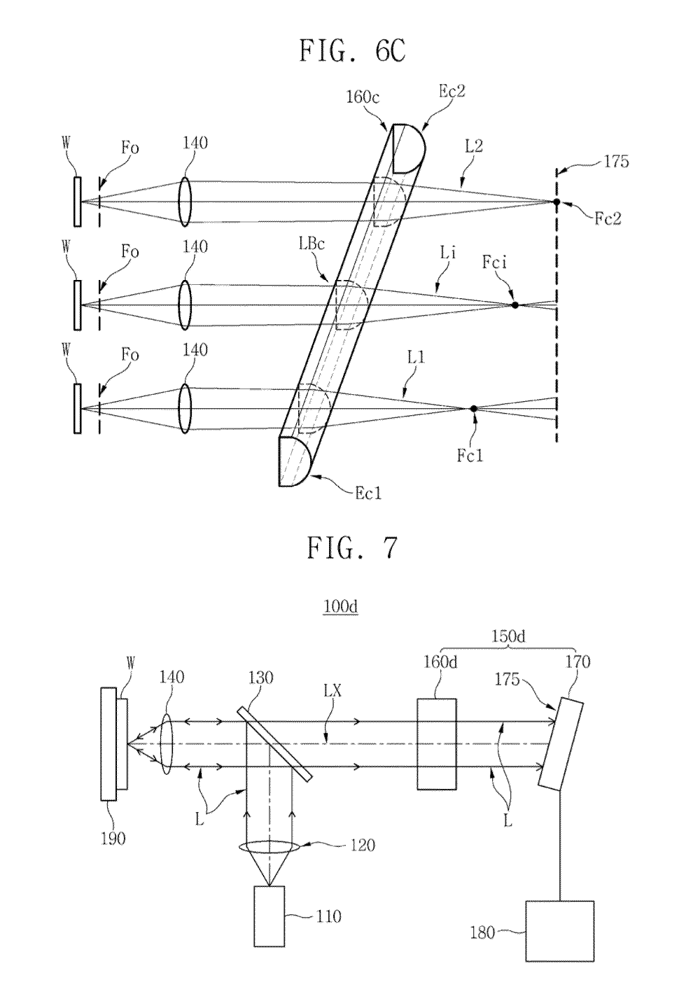

FIGS. 6A to 6C are views for describing a surface level of a workpiece W, which may be measured using the profile measurement system 100c in accordance with exemplary embodiments of the present inventive concept.

Referring to FIGS. 6A to 6C, the lights L1, L2, and Li reflected from the workpiece W may be transmitted through the focusing lens 160c and may be irradiated to the sensing plane 175 of the light detector 170. Focal points Fc1, Fc2, and Fci of the focusing lens 160c may be variously located. The light L1 which may be transmitted through a first end Ec1 of the focusing lens 160c relatively far from the sensing plane 175 may have a first focal point Fc1 which is in front of the sensing plane 175. The light L2 which may be transmitted through a second end Ec2 of the focusing lens 160c relatively close to the sensing plane 175 may have a second focal point Fc2 which is behind the sensing plane 175. The light Li which may be transmitted through a lens body LBc of the focusing lens 160c may have an intermediate focal point Fci located between the first focal point Fc1 and the second focal point Fc2.

For example, referring to FIG. 6A, if a surface of the workpiece W is arranged to match a focal surface Fo of the object lens 140 and the light Li which may be transmitted through the lens body LBc of the focusing lens 160c is focused on the sensing plane 175 of the light detector 170, the light L1 which may be transmitted through a part close to the first end Ec1 of the focusing lens 160c may be focused in front of the sensing plane 175 The light L2 which may be transmitted through the second end Ec2 of the focusing lens 160c may be focused in back of the sensing plane 175. Maximum intensity of the light Li may be obtained at the sensing plane 175 which matches the intermediate focal point Fci.

For example, referring to FIG. 6B, if the surface of the workpiece W is arranged to be closer than the focal surface Fo of the object lens 140, the light L1 which may be transmitted through a part close to the first end Ec1 of the focusing lens 160c, may be focused on the sensing plane 175. Maximum intensity of the light L1 may be obtained at the sensing plane 175 close to the first focal point Fc1.

For example, referring to FIG. 6C, if the surface of the workpiece W is arranged to be farther than the focal surface Fo of the object lens 140, the light L2 which may be transmitted through a part close to the second end Ec2 of the focusing lens 160c, may be focused on the sensing plane 175. Maximum intensity of the light L2 may be obtained at the sensing plane 175 close to the second focal point Fc2.

Referring again to FIGS. 6A to 6C, a mutual positional relationship between the surface of the workpiece W and the focal surface Fo of the object lens 140 may be estimated by analyzing intensity profiles of the lights L1, L2, and Li which reach the sensing plane 175 of the light detector 170.

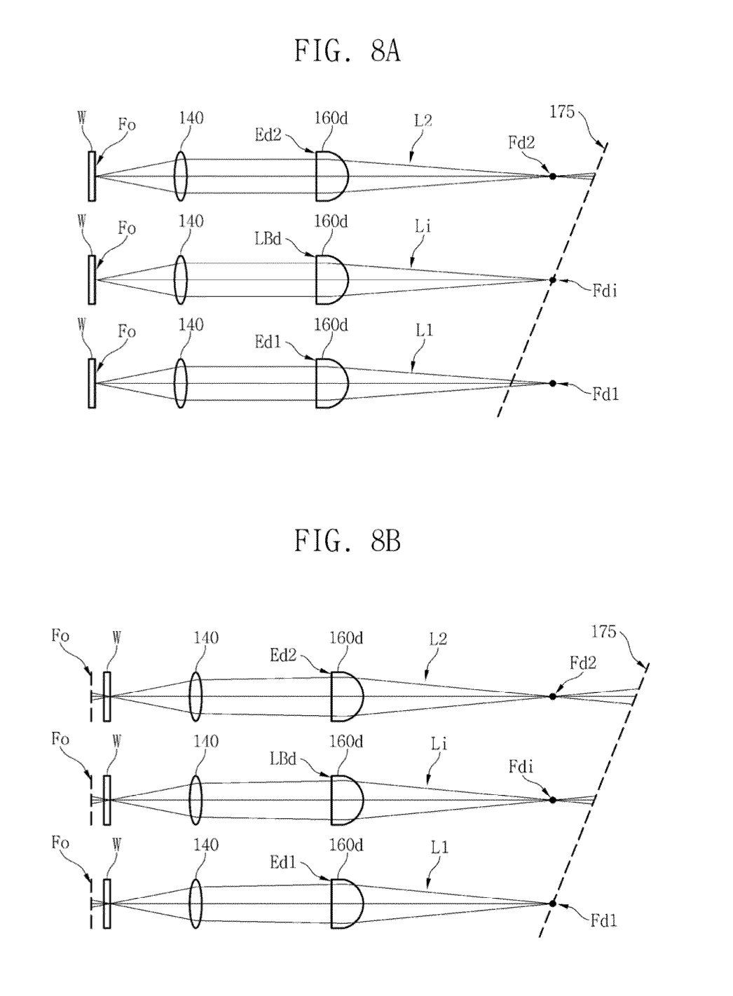

FIG. 7 is a schematic view showing a profile measurement system 100d in accordance with exemplary embodiments of the present inventive concept.

Referring to FIG. 7, the profile measurement system 100d may include a light source 110, a field lens 120, a beam splitter 130, an object lens 140, a profile estimating part 150d, and a stage 190. The profile estimating part 150d may include a focusing lens 160d and a light detector 170 having a sensing plane 175. The sensing plane 175 may be arranged to be tilted with respect to a light axis LX. The focusing lens 160d may include a semi-cylindrical lens having a uniform curvature and thickness. For example, the profile estimating part 150d may have a plurality of continuously varying focal points. The plurality of focal points of the focusing lens 160d may form a focal line. The focal line of the focusing lens 160d may be focused to vary continuously on the sensing plane 175.

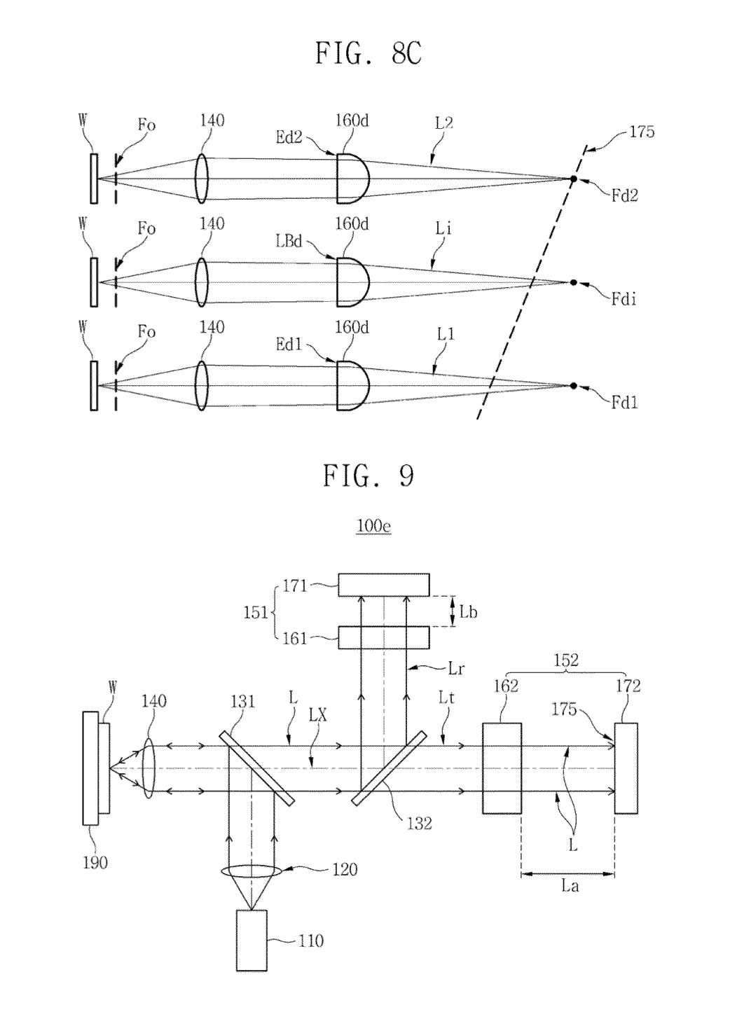

FIGS. 8A to 8C are views for describing a surface level of a workpiece W being measured using the profile measurement system 100d in accordance with exemplary embodiments of the present inventive concept.

Referring to FIGS. 8A to 8C, lights L1, L2, and Li reflected from a workpiece W may be transmitted through the focusing lens 160d to be irradiated to the sensing plane 175 of the light detector 170. Focal points Fd1, Fd2, and Fdi of the focusing lens 160d may be arranged to be tilted with respect to the sensing plane 175.

For example, referring to FIG. 8A, if a surface of the workpiece W is arranged to match a focal surface Fo of the object lens 140 and the light Li which may be transmitted through the lens body LBd of the focusing lens 160d is focused on the sensing plane 175 of the light detector 170, the light L1 which may be transmitted through a part close to a first end Ed1 of the focusing lens 160d may be focused in back of the sensing plane 175. The light L2 which may be transmitted through a second end Ed2 of the focusing lens 160d, may be focused in front of the sensing plane 175. Maximum intensity of the light Li may be obtained at the sensing plane 175 which matches an intermediate focal point Fdi.

For example, referring to FIG. 8B, if the surface of the workpiece W is arranged to be closer than the focal surface Fo of the object lens 140, the light L1 which may be transmitted through a part close to the first end Ed1 of the focusing lens 160d, may be focused on the sensing plane 175. Maximum intensity of the light L1 may be obtained at the sensing plane 175 close to the first focal point Fd1.

For example, referring to FIG. 8C, if the surface of the workpiece W is arranged to be farther than the focal surface Fo of the object lens 140, the light L2 which may be transmitted through a part close to the second end Ed2 of the focusing lens 160d, may be focused on the sensing plane 175. Maximum intensity of the light L2 may be obtained at the sensing plane 175 close to the second focal point Fd2.

Referring again to FIGS. 8A to 8C, a mutual positional relationship between the surface of the workpiece W and the focal surface Fo of the object lens 140 may be estimated by analyzing intensity profiles of the lights L1, L2, and Li which reach the sensing plane 175 of the light detector 170.

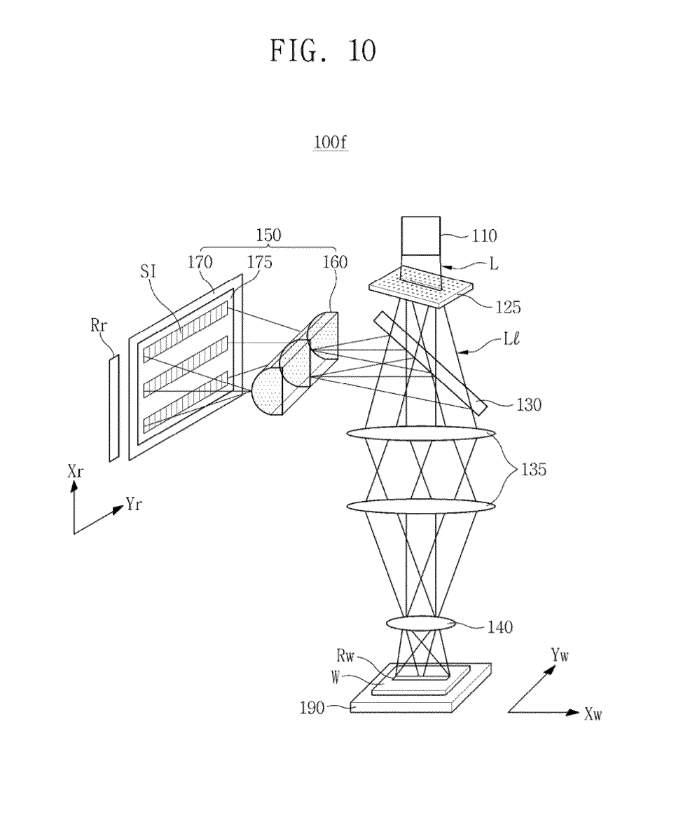

FIG. 9 is a schematic view showing a profile measurement system 100e in accordance with exemplary embodiments of the present inventive concept.

Referring to FIG. 9, the profile measurement system 100e may include a light source 110, a field lens 120, a first beam splitter 131, an object lens 140, a second beam splitter 132, a first profile estimating part 151, and a second profile estimating part 152. The second beam splitter 132 may receive the light L which may be reflected from a workpiece W and may be transmitted through the first beam splitter 131. The beam splitter 132 may partially reflect and partially transmit the light L. The light Lr reflected from the second beam splitter 132 may be analyzed in the first profile estimating part 151. The light Lt transmitted through the second beam splitter 132 may be analyzed in the second profile estimating part 152. The first profile estimating part 151 may include a first focusing lens 161 and a first light detector 171, and the second profile estimating part 152 may include a second focusing lens 162 and a second light detector 172. Each of the first profile estimating part 151 and the second profile estimating part 152 may include one or more among the various profile estimating parts 150a, 150b, 150c, and 150d described above. The first focusing lens 161 and the second focusing lens 162 may include, for example, one or more of the various focusing lenses 160a, 160b, and 160d. Each of the first light detector 171 and the second light detector 172 may include the light detector 170 and the sensing plane 175. A surface level of a workpiece W may be measured by selecting an optimal one of the profile estimating parts 151 and 152, which may depend on characteristics of the workpiece W or characteristics of the surface of the workpiece W. The surface level of the workpiece W may be measured by using the profile estimating parts 151 and 152 at the same time. For example, the two profile estimating parts 151 and 152 may have different inner lengths La and Lb from each other. The inner lengths La and Lb may vary depending on characteristics of the focusing lenses 161 and 162 or light detectors 171 and 172. The inner lengths La and Lb may refer to distances between the focusing lenses 161 and 162, and the light detectors 171 and 172.

According to the profile measurement systems 100a to 100e illustrated in, for example, FIGS. 1A, 3A, 5, 7, and 9 in accordance with exemplary embodiments of the present inventive concept, a surface height at a specific location of the workpiece W may be accurately measured through a single optical photographing.

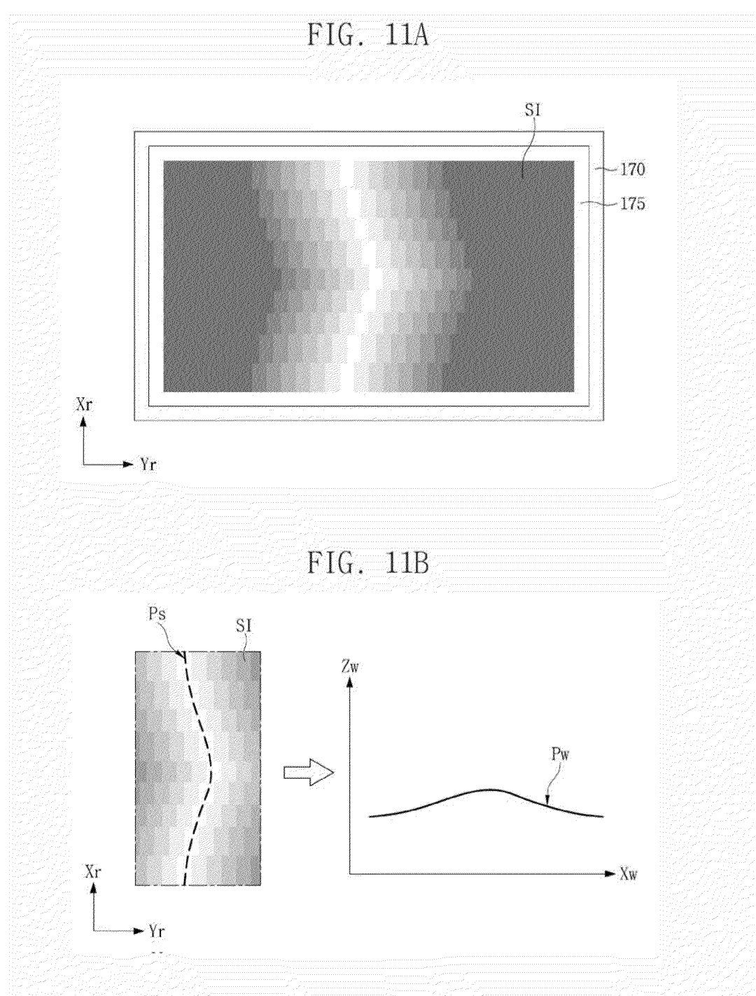

FIG. 10 is a schematic view showing a profile measurement system 100f in accordance with exemplary embodiments of the present inventive concept.

Referring to FIG. 10, the profile measurement system 100f may include a light source 110, a beam shaper 125, a beam splitter 130, transmission lenses 135, an object lens 140, a stage 190, and a profile estimating part 150. The profile estimating part 150 may include a focusing lens 160 and a light detector 170. The profile estimating part 150 may be understood with reference to the profile estimating parts 150a, 150b, 150c, and 150d described above. The profile measurement system 100f may be compatible with the profile measurement systems 100a to 100e. The profile measurement system 100f may include a design different from the profile measurement systems 100a to 100e.

The light source 110 may generate a circular or polygonal light L generated from a point source. The light L generated from the light source 110 may be shaped to an elongated line-shaped light L1 having a line or bar shape by the beam shaper 125. The beam shaper 125 may include an optical aperture with a line- or bar-shaped slit. The term line-shaped light L1 may refer to light L1 that has a line or a bar shape. The line-shaped light L1 shaped may be irradiated to the beam splitter 130. Some of the line-shaped light L1 irradiated to the beam splitter 130 may be transmitted through the beam splitter 130 and may be irradiated to the transmission lenses 135. The line-shaped light L1 irradiated to the transmission lenses 135 may be transmitted through the transmission lenses 135 and may be irradiated to the object lens 140. The line-shaped light L1 irradiated to the object lens 140 may be transmitted through the object lens 140 and may be irradiated to a surface of a workpiece W on the stage 190. The line-shaped light L1 may be irradiated to a line- or bar-shaped illumination region Rw. The illumination region Rw may be aligned in an Xw-axis direction on the surface of the workpiece W. The line-shaped light L1 irradiated to the illumination region Rw of the surface of the workpiece W may be reflected and irradiated back to the object lens 140. The line-shaped light L1 irradiated back to the object lens 140 may be transmitted through the object lens 140 and may be irradiated back to the transmission lenses 135. The line-shaped light L1 irradiated back to the transmission lenses 135 may be transmitted through the transmission lenses 135 and may be irradiated back to the beam splitter 130. Some of the line-shaped light L1 irradiated back to the beam splitter 130 may be reflected on a surface of the beam splitter 130, and irradiated to the focusing lens 160 of the profile estimating part 150. The line-shaped light L1 irradiated to the focusing lens 160 may be irradiated to a sensing plane 175 of the light detector 170. The line-shaped light L1 irradiated to the sensing plane 175 may be displayed on a monitor in the form of a spectral intensity profile showing a Gaussian distribution of brightness differences, an optical image, or other various forms, or converted to an optical or electronic file. Spectral images SI may be formed on the sensing plane 175 and may be separated into three groups. The sensing plane 175 may receive the line-shaped light L1 in the form of a single two-dimensional spectrum. A vertical line- or bar-shaped receiving region Rr may be located beside the light detector 170. The vertical line- or bar-shaped receiving region Rr may correspond with a shape of an illumination region Rw on the surface of the workpiece W. For example, the horizontal Xw-axis of the illumination region Rw of the workpiece W may be converted to an Xr-axis of the receiving region Rr on the light detector 170, and a Yw-axis of the illumination region Rw may be converted to a Yr-axis of the receiving region Rr. The illumination region Rw of the workpiece W may form a spectral image SI showing a plurality of Gaussian distributions in the Yr-axis direction on the sensing plane 175 through the profile estimating part 150.

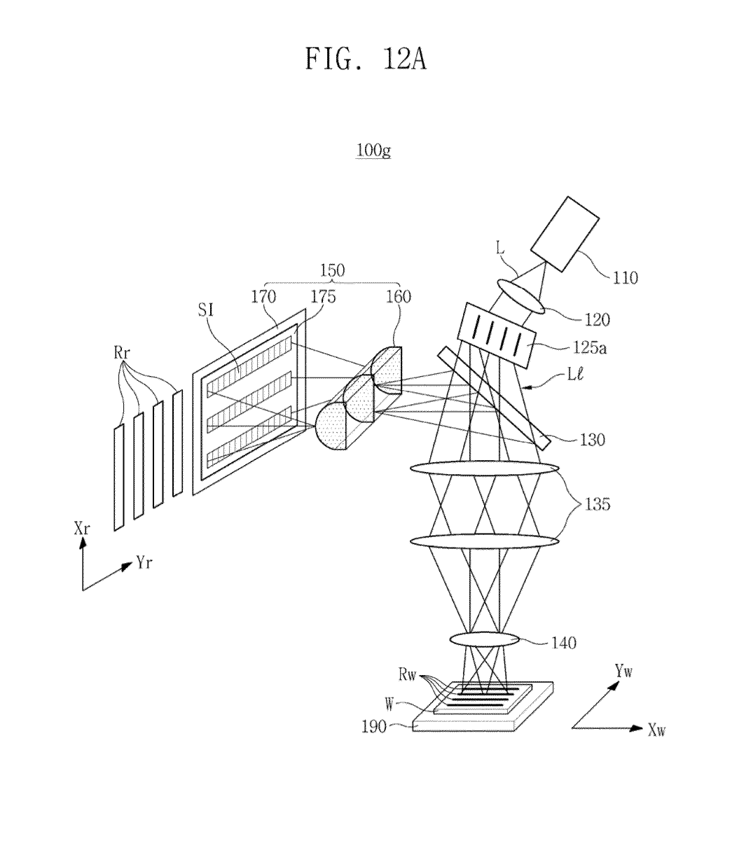

FIGS. 11A and 11B are views for describing a surface profile of a workpiece W being measured using a profile measurement system, for example profile measurement system 100f. For easier understanding of exemplary embodiments of the present inventive concept, it is assumed that each pixel of the sensing plane 175 has a different brightness or intensity from each other pixel and a single pixel has uniform brightness or intensity.

Referring to FIG. 11A, a line-shaped light L1 generated from the light source 110 may be reflected from the illumination region Rw on the workpiece W and may be received on a sensing plane 175 of the light detector 170 in the form of a two-dimensional spectrum SI having a plurality of Gaussian distributions of brightness differences in a one-dimensional direction.

Referring to FIG. 11B, a surface profile Pw of the illumination region Rw of the workpiece W may be obtained by making a graph or image of a spectrum profile Ps connecting locations, areas, or pixels which have maximum intensities. For example the surface profile Pw of the illumination region Rw of the workpiece W may be obtained in the form of a graph or a visual image by converting the Yr-axis direction to a Zw-axis direction which indicates a height or level, and the Xr-axis direction to a Xw-axis direction. This process may be performed at the control part 180.

According to profile measurement systems, for example profile measurement system 100f, a surface profile of a line- or bar-shaped illumination region Rw of the workpiece W may be accurately measured through a single optical image pickup.

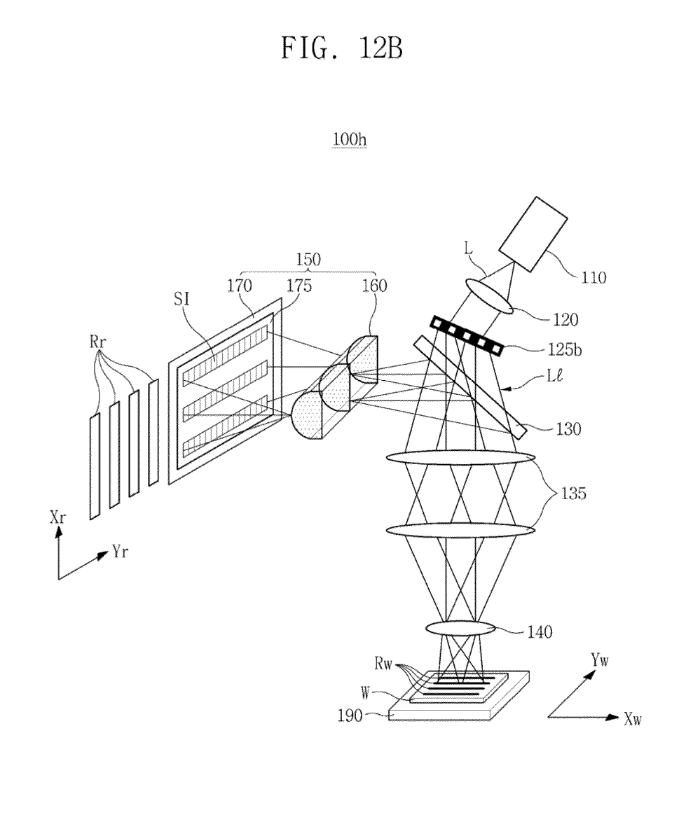

FIGS. 12A and 12B are schematic views showing profile measurement systems 100g and 100h in accordance with exemplary embodiments of the present inventive concept.

Referring to FIGS. 12A and 12B, the profile measurement systems 100g and 100h may include light sources 115, field lenses 120, beam shapers 125a and 125b, beam splitters 130, transmission lenses 135, object lenses 140, stages 190, and profile estimating parts 150. The profile estimating part 150 may include a focusing lens 160 and a light detector 170. The profile estimating part 150 may be understood with reference to the profile estimating parts 150a, 150b, 150c, and 150d described above. The light source 115 may generate a circular or polygonal light L. The light L may be generated by a point source. The light L may have short wavelengths. The light L generated from the light source 115 may be irradiated to the beam shapers 125A and 125B via the field lens 120. The beam shapers 125a and 125b may shape the light L into one or more line-shaped lights L1. The light L may be irradiated to the beam splitter 130. The beam shapers 125a and 125b may shape a plurality of line-shaped lights L1.

Referring to FIG. 12A, the beam shaper 125a may include an acousto-optic diffractor arranged between the light source 110 and the beam splitter 130. Referring to FIG. 12B, the beam shaper 125b may include a diffractive grating arranged between the light source 110 and the beam splitter 130. A surface of the diffractive grating may include alternating regions of prominence and depression. The profile measurement systems 100g and 100h may be compatible with the profile measurement systems 100a to 100e. Profile measurement systems 100g and 100h may include different designs from the profile measurement systems 100a to 100f.

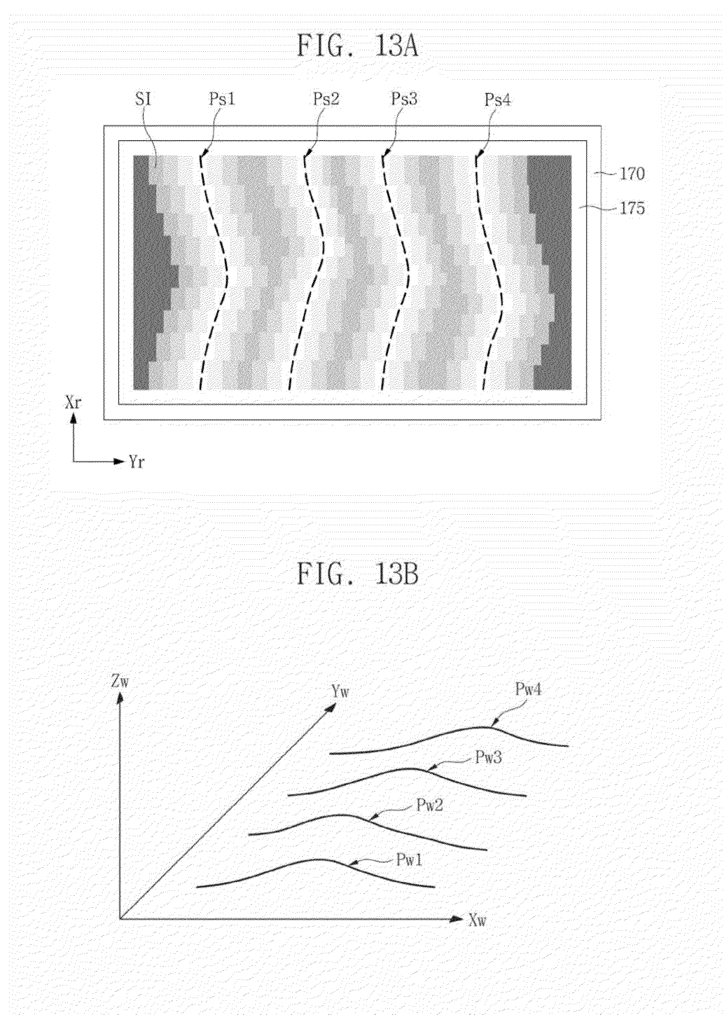

FIGS. 13A and 13B are views for describing a surface profile of a workpiece W measured using the profile measurement systems, for example, profile measurement systems 100g and 100h.

Referring to FIG. 13A, the line-shaped lights L1 generated by the beam shaper may be reflected from the illumination regions Rw of the surface of the workpiece W, and may be received in the form of a two-dimensional spectrum SI having a plurality of Gaussian distributions of brightness differences in a Yr-axis direction on the sensing plane 175 of the light detector 170. For example, the spectrum SI may show intensity profiles corresponding to the number of the line-shaped lights L1.

Referring to FIG. 13B, a surface profile of the illumination regions Rw of the workpiece W may be obtained by making a graph or image through connecting locations, areas, or pixels which have maximum intensities. For example, a surface profile of the illumination regions Rw of the workpiece W may be obtained in the form of a graph or visual image by connecting a plurality of maximum intensity areas existing in each of the illumination regions Rw.

According to the profile measurement systems, for example, profile measurement systems 100g and 100h, a surface profile of a square region on the workpiece W may be accurately measured through a single optical image pickup.

Referring again to FIGS. 10, 12A, and 12B, the illumination region Rw may have a shape aligned in the Xw-axis direction by the light source 115 or the beam shapers 125a and 125b, and the stage 190 may move in the Yw-axis direction. The entire surface of the workpiece W may be scanned and illuminated, and the entire surface profile of the workpiece W may be measured analogically or continuously.

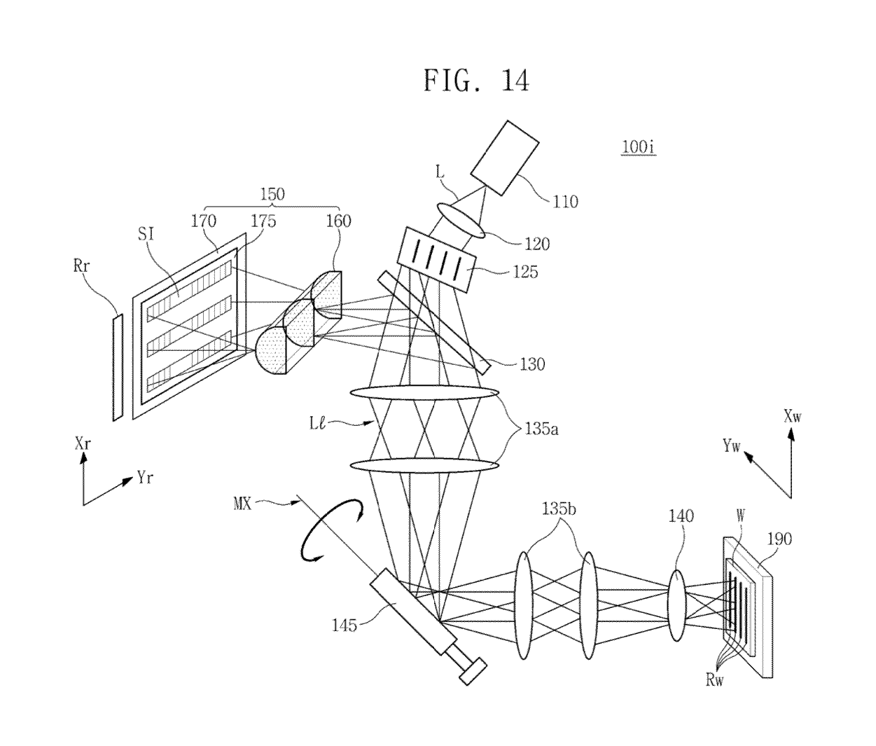

FIG. 14 is a schematic view showing a profile measurement system 100i in accordance with exemplary embodiments of the present inventive concept.

Referring to FIG. 14, the profile measurement system 100i may include a light source 115, a field lens 120, a beam shaper 125, a beam splitter 130, first transmission lenses 135a, a scanning part 145, second transmission lenses 135b, an object lens 140, a stage 190 and a profile estimating part 150. The profile estimating part 150 may include a focusing lens 160 and a light detector 170. The profile estimating part 150 may be understood with reference to the profile estimating parts 150a, 150b, 150c, and 150d. The beam shaper 125 may include an acousto-optic diffractor or a diffractive grating. The profile measurement system 100i may be compatible with the profile measurement systems 100a to 100h. The profile measurement system 100i may include a different design from the profile measurement systems 100a to 100f.

The beam shaper 125 may include an optical aperture. The scanning part 145, for example, may include a mirror, such as a galvano mirror, rotating or flowing in the direction of the arrow with respect to a mirror axis MX. The line-shaped light L1 may be scanned in the Yw-axis direction. The stage 190 of the profile measurement system 100i may be fixed.

The illumination region Rw may have a shape aligned in the Xw-axis direction by the light source 110 or the beam shaper 125, and the entire surface of the workpiece W may be scanned and illuminated by the scanning mirror 145. The entire surface profile of the workpiece W may be measured analogically or continuously.

The foregoing is illustrative of exemplary embodiments of the present inventive concept and is not to be construed as limiting thereof. Although a few embodiments have been described, those skilled in the art will readily appreciate that many modifications are possible without materially departing from the spirit and scope of the present inventive concept.

What is claimed is:

1. A profile measurement system, comprising:
a light source configured to generate light;
a beam shaper configured to shape the light generated from the light source;
a beam splitter configured to partially transmit and partially reflect the light shaped by the beam shaper;
an object lens configured to receive the light from the beam splitter and focus the light to a stage in which a workpiece is mounted; and
a profile estimating part having a plurality of continuously varying focal points,
wherein the profile estimating part includes:
a focusing lens; and
a light detector configured to receive the light transmitted through the focusing lens.

2. The profile measurement system of claim 1, wherein the beam shaper is configured to shape the light generated from the light source into a bar shape.

3. The profile measurement system of claim 2, wherein the profile estimating part comprises a plurality of focal distances continuously varying in a direction perpendicular to a light axis of the bar-shaped light.

4. The profile measurement system of claim 2, wherein the bar-shaped light is irradiated to a bar-shaped irradiation area of which a light axis is placed in a horizontal direction on the stage, and the irradiation area is scanned in a vertical direction.

5. The profile measurement system of claim 1, wherein the focusing lens comprises a semi-cylindrical lens.

6. The profile measurement system of claim 5, wherein the focusing lens comprises:
a first end;
a second end; and
a lens body disposed between the first end and the second end,
wherein the first end has a first focal distance, the second end has a second focal distance farther than the first focal distance, and the lens body has a third focal distance between the first focal distance and the second focal distance.

7. The profile measurement system of claim 6, wherein the first end has a first radius of curvature,
the second end has a second radius of curvature greater than the first radius of curvature, and
the lens body has a third radius of curvature between the first radius of curvature and the second radius of curvature.

8. The profile measurement system of claim 7, wherein the first end, the second end, and the lens body have a common thickness.

9. The profile measurement system of claim 6, wherein the first end has a first thickness, the second end has a second thickness greater than the first thickness, and the lens body has a third thickness that is greater than the first thickness and less than the second thickness.

10. The profile measurement system of claim 9, wherein the first end, the second end, and the lens body have a common radius of curvature.

11. The profile measurement system of claim 6, wherein the focusing lens has a continuous focal line from the first end to the second end, and
both of the focusing lens and the light detector are arranged perpendicular to a light axis.

12. The profile measurement system of claim 5, wherein the focusing lens comprises:
a first end;
a second end; and
a lens body disposed between the first end and the second end,
wherein the first end has a first light path distance from the light detector, the second end has a second light path distance farther than the first light path distance from the light detector, and the lens body has a third light path distance that is greater than the first light path distance and less than the second light path distance.

13. The profile measurement system of claim 12, wherein the focusing lens has a continuous focal line from the first end to the second end, and the focal line is arranged to be tilted with respect to a light axis.

14. The profile measurement system of claim 12, wherein the focusing lens has a focal line from the first end to the second end, the focal line is perpendicular to a light axis, and a surface of the light detector is arranged to be tilted with respect to the light axis.

15. A profile measurement system, comprising:
a light source configured to generate light;
a beam shaper configured to shape the light generated from the light source in a bar shape;
an object lens configured to transmit the bar-shaped light onto an irradiation area on a surface of a workpiece; and
a beam splitter configured to receive the light reflected from the irradiation area on the surface of the workpiece and to transfer the received light to a profile estimating part,
wherein the profile estimating part includes:
a focusing lens comprising a focal line extending in a direction perpendicular to an alignment direction of the light reflected from the irradiation area; and
a light detector comprising a sensing plane on which the light transmitted through the focusing lens splits in the same direction as the focal line.

16. A profile measurement apparatus, comprising:
a light source configured to generate light and irradiate the generated light to a field lens;
the field lens configured to irradiate the generated light to a beam splitter;
the beam splitter configured to partially reflect the light irradiated thereto to an object lens, and to partially transmit the light reflected thereto to a profile estimating part; and
the object lens configured to irradiate the light reflected thereto to a workpiece and transmit the light reflected from the workpiece to the profile estimating part,
wherein the profile estimating part comprises a plurality of continuously varying focal points.

17. The profile measurement apparatus of claim 16, further comprising:
a beam shaper configured to shape the light generated from the light source.

18. The profile measurement apparatus of claim 17, wherein the beam shaper is configured to shape the light generated from the light source in a bar shape.

19. the profile measurement system of claim 16, wherein the profile estimating part comprises a plurality of focal distances continuously varying in a direction perpendicular to a light axis of the light.

20. The profile measurement apparatus of claim 16, further comprising:
a scanning part configured to receive light from the beam splitter.
